(19) United States
(12) Patent Application Publication
(10) Pub. No.: US 2024/0176666 A1
(43) Pub. Date: May 30, 2024

(54) WORKSPACE PROCESSING METHOD AND DEVICE

(71) Applicant: Lenovo (Beijing) Limited, Beijing (CN)

(72) Inventors: Yanli KONG, Beijing (CN); Qigang WANG, Beijing (CN)

(21) Appl. No.: 18/492,103

(22) Filed: Oct. 23, 2023

(30) Foreign Application Priority Data
Nov. 30, 2022 (CN) 202211521749.1

(51) Int. Cl. G06F 9/50

(52) U.S. Cl. CPC G06F 9/5027

(57) ABSTRACT

A workspace processing method including receiving a first creation request to create a target sub-workspace based on a target workspace being in an operating state, the first creation request including a target workspace identifier and a second resource required by the target sub-workspace; determining a first node to which the target workspace belongs and a first resource of the target workspace based on the target workspace identifier, the first resource being an available resource of the target workspace; and creating the target sub-workspace on the first node based on the first resource of the target workspace meeting requirements of the second resource.

### CROSS-REFERENCES TO RELATED APPLICATION

This application claims priority to Chinese Patent Application No. 202211521749.1 filed on Nov. 30, 2022, the entire content of which is incorporated herein by reference.

### FIELD OF TECHNOLOGY

The present disclosure relates to the field of information technology and, more specifically, to a workspace processing method and device.

### BACKGROUND

A workspace refers to a group of resources with “network interoperability, consistent security policies, and minimal access delay”. Users can easily group and manage resources through the workspace.

In platforms that support workspace tasks, users can apply for a workspace in a certain environment through the platform. Each user can apply for multiple workspaces at the same time, and can specify the number of resources occupied by the workspace during the application process.

When a user applies for a workspace, the user needs to create a new workspace through a platform page. The new workspace will be in an operating state after it is assigned to a computing node. Every time a new workspace is created, the request to create a new workspace will be put into a scheduling queue and wait to be scheduled. When there are sufficient resources, the workspace space request will be in an operating state, otherwise, it will wait in the queue. After a user creates a workspace and needs to apply for a new workspace, when the platform resources are limited, the user needs to wait for a long time before resources are allocated to enable a new workspace, which results in a poor user experience.

### SUMMARY

One aspect of this disclosure provides a workspace processing method. The workspace processing method includes receiving a first creation request to create a target sub-workspace based on a target workspace being in an operating state, the first creation request including a target workspace identifier and a second resource required by the target sub-workspace; determining a first node to which the target workspace belongs and a first resource of the target workspace based on the target workspace identifier, the first resource being an available resource of the target workspace; and creating the target sub-workspace on the first node based on the first resource of the target workspace meeting requirements of the second resource.

Another aspect of this disclosure provides a workspace processing device. The workspace processing device includes a receiving module, a determination module, and a creation module. The receiving module is configured to receive a first creation request to create a target sub-workspace based on a target workspace being in an operating state, the first creation request including a target workspace identifier and a second resource required by the target sub-workspace. The determination module is configured to determine a first node to which the target workspace belongs and a first resource of the target workspace based on the target workspace identifier, the first resource being an available resource of the target workspace. The creation module is configured to create the target sub-workspace on the first node based on the first resource of the target workspace meeting requirements of the second resource.

Another aspect of this disclosure provides an electronic device. The electronic device includes a processor and a memory. The memory stores a computer program that, when executed, causes the processor to receive a first creation request to create a target sub-workspace based on a target workspace in an operating state, the first creation request including a target workspace identifier and a second resource required by the target sub-workspace; determine a first node to which the target workspace belongs and a first resource of the target workspace based on the target workspace identifier, the first resource being an available resource of the target workspace; and create the target sub-workspace on the first node based on the first resource of the target workspace meeting requirements of the second resource.

### BRIEF DESCRIPTION OF THE DRAWINGS

In order to illustrate the technical solutions in accordance with the embodiments of the present disclosure more clearly, the accompanying drawings to be used for describing the embodiments are introduced briefly in the following. It is apparent that the accompanying drawings in the following description are only some embodiments of the present disclosure. Persons of ordinary skill in the art can obtain other accompanying drawings in accordance with the accompanying drawings without any creative efforts.

FIG. 1 is a flowchart of a workspace processing method according to an embodiment of the present disclosure.

FIG. 2 is a flowchart of the workspace processing method according to an embodiment of the present disclosure.

FIG. 3 is a flowchart of the workspace processing method according to an embodiment of the present disclosure.

FIG. 4 is a flowchart of the workspace processing method according to an embodiment of the present disclosure.

FIG. 5 is a flowchart of the workspace processing method according to an embodiment of the present disclosure.

FIG. 6 is a flowchart of the workspace processing method according to an embodiment of the present disclosure.

FIG. 7 is a flowchart of the workspace processing method according to an embodiment of the present disclosure.

FIG. 8 is a flowchart of the workspace processing method according to an embodiment of the present disclosure.

FIG. 9 is a flowchart of the workspace processing method according to an embodiment of the present disclosure.

FIG. 10 is a schematic diagram of an application scenario of the workspace processing method according to an embodiment of the present disclosure.

FIG. 11 is a sequence diagram for creating workspaces and sub-workspaces in an application scenario of the workspace processing method provided by the present disclosure.

FIG. 12 is a schematic structural diagram of the electronic device according to an embodiment of the present disclosure.

### DETAILED DESCRIPTION

Technical solutions of the present disclosure will be described in detail with reference to the drawings. It will be appreciated that the described embodiments represent some, rather than all, of the embodiments of the present disclosure. Other embodiments conceived or derived by those having ordinary skills in the art based on the described embodiments without inventive efforts should fall within the scope of the present disclosure.

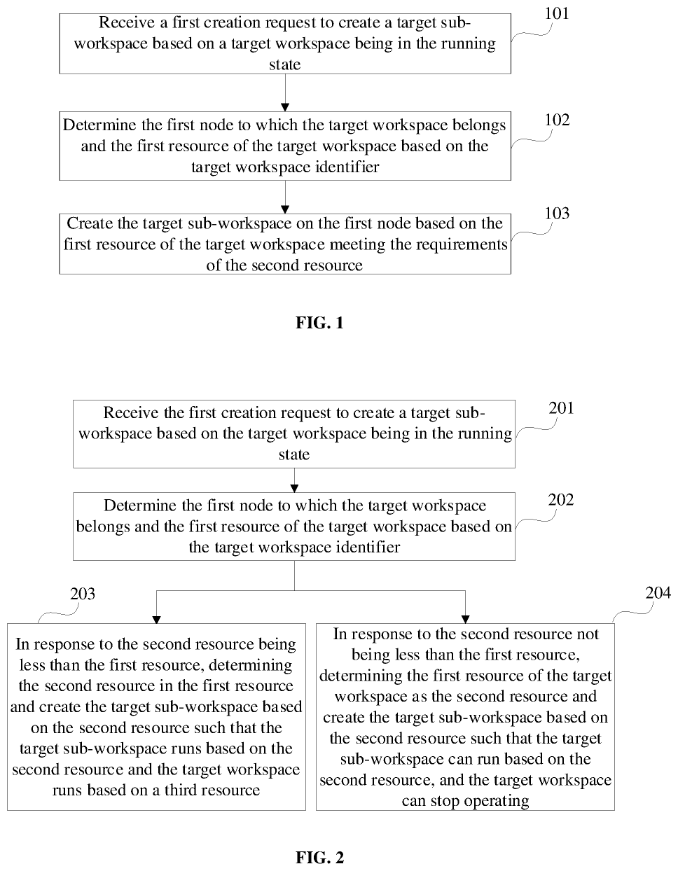

FIG. 1 is a flowchart of a workspace processing method according to an embodiment of the present disclosure. The method can be applied to an electronic device. The method will be described in detail below.

101, receiving a first creation request to create a target sub-workspace based on a target workspace being in the operating state.

In some embodiments, the first creation request may include a target workspace and a second resource required by the target sub-workspace.

In some embodiments, the electronic device may be the device on which the platform supports workspace tasks, such as a server node, a master node, etc.

In some embodiments, the workspace may be a workspace task based on a docker (i.e., a container engine). The platform may support multiple environments, such as tensorflow, pytorch, kaldi, and other popular deep learning environments.

In some embodiments, the target workspace may be a workspace in the operating state, which can run based on occupied resources.

It should be noted that when a workspace is in the operating state, its corresponding resources may be occupied, and the resources it occupies cannot be used by other workspaces. When a workspace is in a finished state, the resources it occupies can be returned to the resource pool and can be occupied by any other workspace.

In some embodiments, an operator may input the first creation request to create the target sub-workspace through an input device to create the target sub-workspace in the target workspace in the operating state.

In some embodiments, the generated first creation request may include the target workspace identifier and the second resource required by the target sub-workspace.

In some embodiments, the target workspace identifier may be a unique identifier of the workspace. The second resource required by the target sub-workspace may be a required number of processor model resources and the number of storage resources, etc.

In some embodiments, before the process at 101, there may be a process of creating the target workspace. The process of creating the target workspace may include: 001, receiving a creation request to create the target workspace, and 002, allocating the target workspace to a first node based on the first resource requested in the creation request, the idle resource of the first node being greater than the first resource.

102, determining the first node to which the target workspace belongs and the first resource of the target workspace based on the target workspace identifier.

In some embodiments, the first resource may be an available resource of the target workspace.

In some embodiments, based on the target workspace identifier in the first creation request, the first node to which the target workspace belongs and the first resource available to the target workspace may be determined.

In some embodiments, the electronic device may perform the work of allocating nodes to the workspace, and store information about the nodes to which each assigned workspace belongs and the resources it occupies.

More specifically, after receiving the first creation request, the electronic device may obtain the node to which the target workspace belongs and its occupied resources based on the target workspace identifier, which the occupied resources may be available resources.

103, creating the target sub-workspace on the first node based on the first resource of the target workspace meeting the requirements of the second resource.

In some embodiments, the first resource of the target workspace may be determined to ensure it meets the requirements of the second resource. More specifically, the requirements of the second resource may include the processor model, the number of processor resources, the number of storage space resources, etc.

More specifically, whether the environment and the number of resources of the target workspace meet the reequipments of the second resource may be determined. In some embodiments, whether the environment meets the requirements may include whether the processor model used by the target workspace meets the requirements of the second resource. For example, the processor may include the central processing unit (CPU) used by the node where the target workspace is located.

In some embodiments, if the first resource occupied by the target workspace meets the requirements of the second resource of the target sub-workspace, the target sub-workspace may be created on the first node to which the target sub-workspace belongs such that the target sub-workspace can run based on the second resource.

In a specific implementation, a button to create a sub-workspace may be preset in the interface of the target workspace. Based on triggering this button, a dialog box for creating a sub-workspace may pop up. The operator may enter the required resources of the target sub-workspace in the dialog box, and generate the first creation request based on the content entered in the dialog box.

Since the first creation request is generated based on the preset dialog box of the target workspace, the processor requirements of the first creation request may be set based on the processor of the target workspace. Therefore, in the process at 103, there is no need to determine whether the first resource of the target workspace meets the requirements of the second resource, thereby reducing the data processing burden of the electronic device.

It should be noted that since only one or several workspaces may be operating on the platform that performs workspace tasks at a certain time, and the resources of the operating workspaces are occupied, therefore, when a target sub-workspace is created (or incubated) in a operating workspace, the incubated sub-workspace may directly utilize the resources of the workspace without waiting for resources in the resource pool.

It should be noted that in a certain workspace, a plurality of sub-workspaces may be created, and each sub-workspace may share the resources of the workspace. Each time a sub-workspace is created in this workspace, the sub-workspace may be created based on the available resources in the workspace. The available resources may be the remaining resources in addition to the resources occupied by the created sub-workspace.

Consistent with the present disclosure, the workspace processing method may include: receiving the first creation request to create a target sub-workspace based on the target workspace in the operating state, the first creation request including the target workspace identifier and the second resource required by the target sub-workspace; determining the first node to which the target workspace belongs and the first resource of the target workspace based on the target workspace identifier, the first resource being an available resource of the target workspace; and creating the target sub-workspace on the first node based on the first resource of the target workspace meeting the requirements of the second resource. In this embodiment, after the target workspace has been created, if another workspace is created, the target sub-workspace can be created in the target workspace that has been created and is in operating state, without waiting for resource allocation in the platform, thereby using the available resources in the target workspace to create a target sub-workspace at the first node of the target workspace, which reduces the waiting time for creating the workspace required by the user.

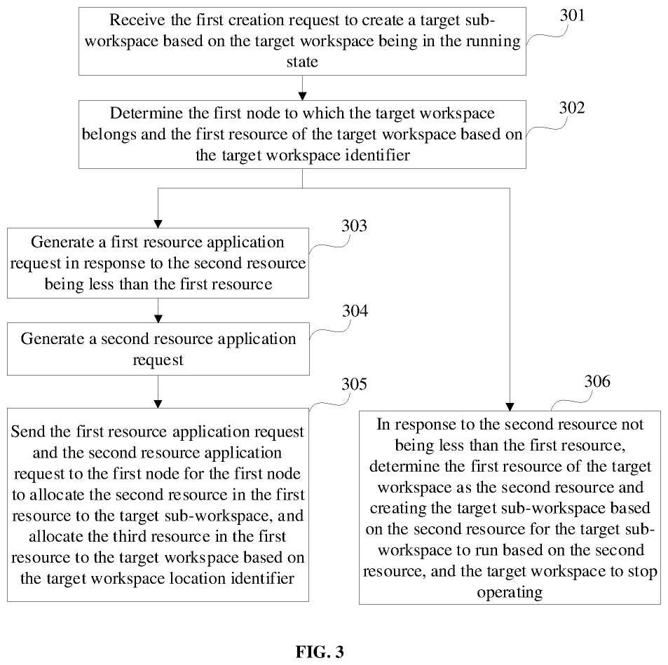

FIG. 2 is a flowchart of the workspace processing method according to an embodiment of the present disclosure. The method will be described in detail below.

201, receiving the first creation request to create a target sub-workspace based on a target workspace being in the operating state.

202, determining the first node to which the target workspace belongs and the first resource of the target workspace based on the target workspace identifier.

The processes at 201 and 202 are consistent with the processes at 101 and 102, and will not be described in detail again.

It should be noted that during the process of creating the target sub-workspace, there may be two situations where the second resource is less than the first resource and the second resource is not less than the first resource. In a specific implementation, during the process of creating a target sub-workspace, only one of these situations will be encountered. Therefore, during the process of creating a target sub-workspace, the process at 203 or the process at 204 may be performed, which will be described in detail in the following embodiments.

203, in response to the second resource being less than the first resource, determining the second resource in the first resource and create the target sub-workspace based on the second resource such that the target sub-workspace runs based on the second resource and the target workspace runs based on a third resource.

In some embodiments, the first resource may be the remaining resource in the first resource other than the second resource.

In some embodiments, if the second resource required by the target sub-workspace is less than the first resource occupied by the target workspace, the second resource and the remining third resource may be determined in the first resource.

In some embodiments, the target sub-workspace may be created based on the second resource determined in the first resource such that the created target sub-workspace can run based on the second resource and the target workspace can run based on the remaining third resource.

It should be noted that the process of creating a target sub-workspace will be described in detail in subsequent embodiments, and will not be described in detail here.

204, in response to the second resource not being less than the first resource, determining the first resource of the target workspace as the second resource and create the target sub-workspace based on the second resource such that the target sub-workspace can run based on the second resource, and the target workspace can stop operating.

In some embodiments, if the second resource required by the target sub-workspace created by the request is not less than the first resource, the entire first resource of the target workspace may be used as the second resource to create the target sub-workspace based on the second resource. Since there are no resources left in the target workspace, the operation of the target workspace can be stopped.

It should be noted that if the second resource is equal to the first resource, all the first resources can be used as the second resource; if the second resource is greater than the first resource, all the first resources may be used as the second resource, or an error message may be provided to prompt the user to enter a required resource that is greater than what the target workspace can provide.

It should be noted that if the platform of the workspace task has strict requirements for the to-be-created target sub-workspace resource, then only a creation request to create a target sub-workspace where the second resource is not greater than the first resource may be generated.

It should be noted that the process of creating a target sub-workspace will be described in detail in subsequent embodiments, and will not be described in detail here.

Consistent with the present disclosure, the workspace processing method may include one of the following: if the second resource is less than the first resource, determining the second resource in the first resource and create the target sub-workspace based on the second resource such that the target sub-workspace runs based on the second resource and the target workspace runs based on a third resource, the third resource being the remaining resource in the first resource other than the second resource; if the second resource is not less than the first resource, determining the first resource of the target workspace as the second resource and create the target sub-workspace based on the second resource such that the target sub-workspace can run based on the second resource, and the target workspace can stop operating. In this embodiment, if the requested second resource is less than the first resource occupied by the target workspace, the created target sub-workspace may share the first resource with the target workspace; if the requested second resource is not less than the first resource, the created target sub-workspace may exclusively occupy the second resource to ensure the operation of the created target sub-workspace.

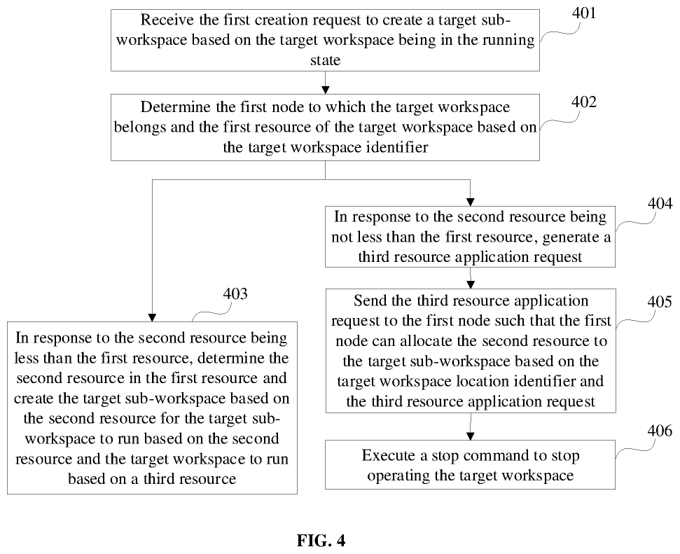

FIG. 3 is a flowchart of the workspace processing method according to an embodiment of the present disclosure. The method will be described in detail below.

301, receiving the first creation request to create a target sub-workspace based on the target workspace being in the operating state.

302, determining the first node to which the target workspace belongs and the first resource of the target workspace based on the target workspace identifier.

The processes at 301 and 302 are consistent with the processes at 201 and 202, and will not be described in detail again.

303, generating a first resource application request in response to the second resource being less than the first resource.

In some embodiments, the first resource application request may include a target workspace location identifier and the second resource required by the target sub-workspace.

304, generating a second resource application request.

In some embodiments, the second resource application request may include the target workspace location identifier and the third resource required by the target workspace.

In some embodiments, to realize that the target sub-workspace and the target workspace share the first resource, resource application requests may be generated respectively to request the second resource required by the target sub-workspace and the remaining third resource of the target workspace.

In some embodiments, the first resource application request and the second resource application request may be generated. The first resource application request may include the target workspace location identifier and the second resource required by the target sub-workspace. The second resource application request may include the target workspace location identifier and the third resource of the target workspace. The target workspace location identifier may be used to prompt the first node to share resources occupied by the target workspace.

In some embodiments, the target workspace location identifier may be the storage ID (for storing identity document) of the target workspace in the first node.

In this way, through the first resource application request and the second resource application request, the first node may share the first resource of the target workspace and the target sub-workspace, thereby ensuring the allocation of resources of the target sub-workspace, and the remaining resources are used as resources for the target workspace to run.

305, sending the first resource application request and the second resource application request to the first node for the first node to allocate the second resource in the first resource to the target sub-workspace, and allocate the third resource in the first resource to the target workspace based on the target workspace location identifier.

In some embodiments, the first resource application request and the second resource application request may be sent to the first node such that the first node can allocate the second resource and the third resource to the target sub-workspace and the target workspace respectively based on the first resource of the target workspace.

More specifically, the first node may determine the location of the resource of the target workspace based on the target workspace location identifier, determine the location of the first resource, and then allocate the resources at that location to allocate the second resource and the third resource to the target sub-workspace and the target workspace respectively.

It should be noted that after the first node allocate the third resource to the target workspace based on the second resource application request, the target workspace may restart to run based on the third resource. After the first node allocates the second resource to the target sub-workspace based on the first resource, the target sub-workspace may start and run based on the second resource. Alternatively, after the process at 302, the process at 306 may be performed.

306, in response to the second resource not being less than the first resource, determining the first resource of the target workspace as the second resource and creating the target sub-workspace based on the second resource for the target sub-workspace to run based on the second resource, and the target workspace to stop operating.

The process at 306 is consistent with the process at 204, which will not be described again here.

Consistent with the present disclosure, the workspace processing method may include generating the first resource application request, the first resource application request including the target workspace location identifier and the second resource required by the target sub-workspace; generating the second resource application request, the second resource application request including the target workspace location identifier and the third resource required by the target workspace; and sending the first resource application request and the second resource application request to the first node for the first node to allocate the second resource in the first resource to the target sub-workspace, and allocate the third resource in the first resource to the target workspace based on the target workspace location identifier. In this embodiment, when the second resource is less than the first resource, the first resource application request and the second resource application request may be generated respectively such that the first node can allocate the second resource in the first resource to the target sub-workspace and allocate the third resource in the first resource to the target sub-workspace, thereby ensuring the second resource required by the target sub-workspace, and achieving the purpose of sharing the first resource between the target sub-workspace and the target workspace.

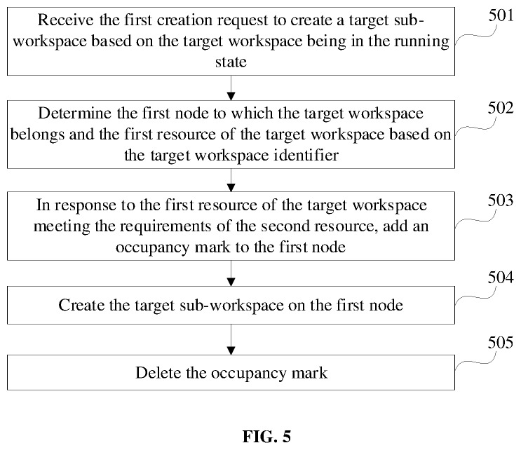

FIG. 4 is a flowchart of the workspace processing method according to an embodiment of the present disclosure. The method will be described in detail below.

401, receiving the first creation request to create a target sub-workspace based on the target workspace being in the operating state.

402, determining the first node to which the target workspace belongs and the first resource of the target workspace based on the target workspace identifier.

403, in response to the second resource being less than the first resource, determining the second resource in the first resource and creating the target sub-workspace based on the second resource for the target sub-workspace to run based on the second resource and the target workspace to run based on a third resource.

The processes at 401 to 403 are consistent with the processes at 201 to 203, and will not be described in detail again. Alternatively, after the process at 402, the processes at 404 to 406 may be performed.

404, in response to the second resource being not less than the first resource, generating a third resource application request.

In some embodiments, the third resource application request may include the target workspace location identifier and the second resource required by the target sub-workspace.

In some embodiments, to share the first resource of the target workspace with the target sub-workspace, the third resource application request may be generated to request the second resource required by the target sub-workspace.

More specifically, the generated third resource application request may also include a target workspace location identifier to prompt the first node to share the resources occupied by the target workspace.

405, sending the third resource application request to the first node such that the first node can allocate the second resource to the target sub-workspace based on the target workspace location identifier and the third resource application request.

In some embodiments, the third resource application request may be sent to the first node such that the first node can allocate the second resource to the target sub-workspace based on the first resource of the target workspace.

More specifically, the first node may determine the location of the resource of the target workspace based on the target workspace location identifier, determine the location of the first resource, and then allocate the resources at the location to allocate all the resources of the first resource to the target sub-workspace.

406, executing a stop command to stop operating the target workspace.

In some embodiments, since all the resources of the target workspace may be shared with the target sub-workspace, the target workspace may have no resources available, and the operating state of the target workspace can be stopped.

More specifically, the stop command may be called through a preset channel in a platform that supports workspace tasks to achieve the purpose of stopping the target workspace.

In some embodiments, the platform may have a preset stop interface, and the stop interface may be called through the preset channel to stop the target workspace.

It should be noted that after the first node allocates the second resource to the target sub-workspace based on the third resource application request, the target sub-workspace may start and run based on the second resource.

Consistent with the present disclosure, the workspace processing method may include generating a third resource application request, the third resource application request including the target workspace location identifier and the second resource required by the target sub-workspace; sending the third resource application request to the first node such that the first node can allocate the second resource to the target sub-workspace based on the target workspace location identifier and the third resource application request; and executing a stop command to stop operating the target workspace. In this embodiment, when the second resource is not less than the first resource, the third resource application request can be generated such that the first node can allocate all the first resource to the target sub-workspace and stop and operation of the target workspace to ensure that target sub-workspace can have the required second resource.

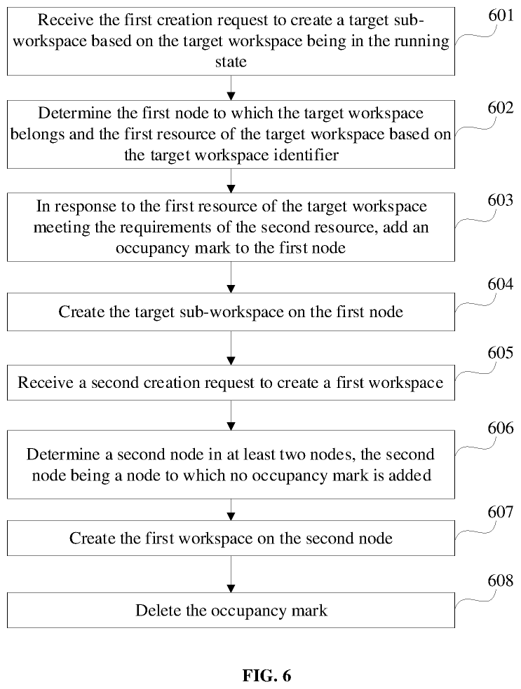

FIG. 5 is a flowchart of the workspace processing method according to an embodiment of the present disclosure. The method will be described in detail below.

501, receiving the first creation request to create a target sub-workspace based on the target workspace being in the operating state.

502, determining the first node to which the target workspace belongs and the first resource of the target workspace based on the target workspace identifier.

The processes at 501 and 502 are consistent with the processes at 101 and 102, and will not be described in detail again.

503, in response to the first resource of the target workspace meeting the requirements of the second resource, adding an occupancy mark to the first node.

In some embodiments, if the first resource of the target workspace meets the requirements of the second resource, the first resource may be shared with the target sub-workspace, and during the process of the first node creating the target sub-workspace, an occupancy mark can be added to the first node.

In some embodiments, the occupancy mark may exist during the process of the first node creating the target sub-workspace such that during the creation process, the first node is exclusive, and the first node is in a state where new workspace cannot be allocated.

In some embodiments, the occupancy mark may be a taint with a specific format. The node with the added occupancy mark may indicate that it is occupied and cannot be allocated a new workspace, and cannot be occupied by the creation process of other workspaces/sub-spaces.

More specifically, the occupation may be the storage ID of the target workspace in the first node, indicating that it can only be occupied by the creation process that shares the target workspace and cannot be occupied by other creation processes.

In some embodiments, the occupancy mark may be the same as the target workspace identifier.

In some embodiments, after determining that the first node to which the target workspace belongs and the first resource of the target workspace meet the requirements of the second resource, an occupancy mark can be added to the first node to which the target workspace belongs, and a target sub-workspace can be created on the first node.

In some embodiments, the platform that executes workspace tasks may store each workspace identifier, each node identifier, the corresponding relationship between the workspace and the node.

More specifically, in some embodiments, adding the taint may indicate adding an occupancy mark to the first node recorded in the storage space on the platform such that the first node cannot be created later during the creation of a workspace/sub-workspace.

504, creating the target sub-workspace on the first node.

The process at 504 is consistent with the process at 103, and will not be described in detail again.

505, deleting the occupancy mark.

In some embodiments, after the first node completes the creation of the target sub-workspace, upon receiving the completion feedback from the first node, the occupancy mark of the first node can be deleted, and the first node can be released from the occupied state.

In some embodiments, at a subsequent moment, the first node can continue to be used to create other workspaces/sub-spaces.

Consistent with the present disclosure, the workspace processing method provided by the embodiments of the present disclosure may also include: adding an occupancy mark to the first node. Correspondingly, after the first node creates the target sub-workspace, the method may further include: deleting the occupancy mark. In this embodiment, before the first node creates the target sub-workspace, an occupancy mark can be added to the first node to ensure that during the process of creating the target sub-workspace, the first node is occupied and cannot be allocated a new workspace. After the creation of the target sub-workspace is completed, the occupancy mark of the first node can be deleted, and the first node can be allocated a new workspace, thereby ensuring that the first node is not affected by the operations of other allocated workspaces during the process of creating the target sub-workspace.

FIG. 6 is a flowchart of the workspace processing method according to an embodiment of the present disclosure. The method will be described in detail below.

601, receiving the first creation request to create a target sub-workspace based on the target workspace being in the operating state.

602, determining the first node to which the target workspace belongs and the first resource of the target workspace based on the target workspace identifier.

603, in response to the first resource of the target workspace meeting the requirements of the second resource, adding an occupancy mark to the first node.

604, creating the target sub-workspace on the first node.

The processes at 601 to 604 are consistent with the processes at 501 to 504, and will not be described in detail again.

605, receiving a second creation request to create a first workspace.

In some embodiments, during the process of creating the target sub-workspace on the first node, a second creation request can be received to create a new workspace.

In some embodiments, the second creation request to create the first workspace may include information such as resources required by the first workspace.

606, determining a second node in at least two nodes, the second node being a node to which no occupancy mark is added.

In some embodiments, the electronic device executing this embodiment may be a master node, and the at least two nodes may be computing nodes (worker nodes) cooperating with the master node.

In some embodiments, the second node that meets the resource requirements required by the first workspace may be determined from multiple nodes based on the information such as resources required by the first workspace.

In some embodiments, if the remaining resources of the first node and the second node both meet the resource requirements required by the first workspace, but the first node has an occupancy mark, the second node with no occupancy mark will be selected.

607, creating the first workspace on the second node.

In some embodiments, the first workspace may be crated on the determined second node.

More specifically, a resource application request to create the first workspace may be generated and sent to the second node such that the second node can allocate its requested resources to the first workspace and start the first workspace, thereby achieving the purpose of creating the first workspace.

608, deleting the occupancy mark.

The process at 608 is consistent with the process at 505, and will not be described in detail again.

Consistent with the present disclosure, the workspace processing method provided by the embodiments of the present disclosure may also include: receiving a second creation request to create a first workspace; determining a second node in at least two nodes, the second node being a node to which no occupancy mark is added; and creating the first workspace on the second node. In this embodiment, when the first node has an occupancy mark and a second creation request to create the first workspace is received, the second node can be determined from a plurality of nodes with no occupancy mark added. The first workspace can be created on the second node to ensure that even if the first node is occupied, the process of creating the workspace can still be executed.

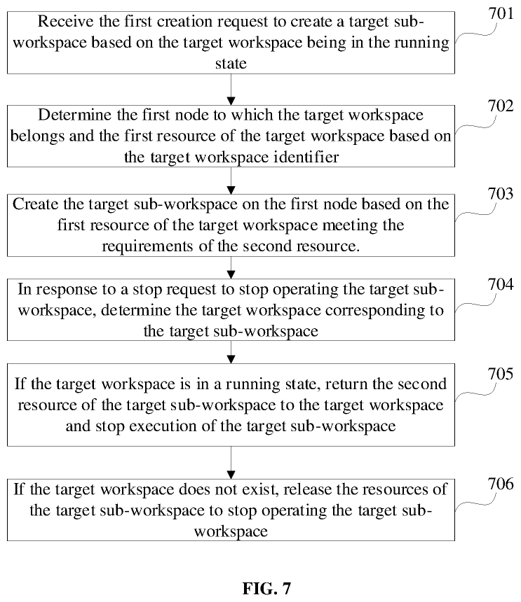

FIG. 7 is a flowchart of the workspace processing method according to an embodiment of the present disclosure. The method will be described in detail below.

701, receiving the first creation request to create a target sub-workspace based on the target workspace being in the operating state.

702, determining the first node to which the target workspace belongs and the first resource of the target workspace based on the target workspace identifier.

703, creating the target sub-workspace on the first node based on the first resource of the target workspace meeting the requirements of the second resource.

The processes at 701 to 703 are consistent with the processes at 101 to 103, and will not be described in detail again.

704, in response to a stop request to stop operating the target sub-workspace, determining the target workspace corresponding to the target sub-workspace.

In some embodiments, after the use of the target sub-workspace is completed, the operator may input a stop request through an input device to stop the operating state of the target sub-workspace.

In some embodiments, the stop request may include the target sub-workspace targeted to stop.

In some embodiments, based on the stored workspace identifier and the incubated sub-workspaces in each workspace, the target workspace corresponding to the target sub-workspace targeted to stop may be determined.

705, if the target workspace is in an operating state, returning the second resource of the target sub-workspace to the target workspace and stopping execution of the target sub-workspace.

In some embodiments, after determining the target workspace corresponding to the stopped target sub-workspace, the state of the target workspace may be determined, the state including operating state or non-operating state.

In some embodiments, if the target workspace is in an operating state, the second resource of the target sub-workspace may be returned to the target workspace, and the operating state of the target sub-workspace may be stopped.

In some embodiments, the target workspace may combine the returned second resource and its original third resource to determine the first resource to run based on the first resource, and the target workspace may be restored to the state when the target sub-workspace is not incubated.

In some embodiments, the stop command may be called through the preset channel in the platform that supports workspace tasks to achieve the purpose of stopping the target sub-workspace.

In some embodiments, the platform may include a preset stop interface, and the stop interface may be called through the preset channel to stop the target sub-workspace.

706, if the target workspace does not exist, releasing the resources of the target sub-workspace to stop operating the target sub-workspace.

In some embodiments, if the target workspace does not exist and the second resource occupied by the target sub-workspace cannot be returned to the target workspace, the resources occupied by the target sub-workspace may stop operating the target sub-workspace.

In some embodiments, a resource pool may be set up for the resources of each computing node in the platform, and the resources of the target sub-workspace may be returned to the resource pool such that other workspaces can subsequently utilize the resources in the first node.

Consistent with the present disclosure, the workspace processing method provided by the embodiments of the present disclosure may also include: in response to a stop request to stop operating the target sub-workspace, determining the target workspace corresponding to the target sub-workspace; if the target workspace is in an operating state, returning the second resource of the target sub-workspace to the target workspace and stopping execution of the target sub-workspace; and if the target workspace does not exist, releasing the resources of the target sub-workspace to stop operating the target sub-workspace. In this embodiment, in response to a stop request to stop operating the target sub-workspace, the target workspace corresponding to the target sub-workspace may be determined. If the target workspace is in the operating state, the second resource occupied by the target sub-workspace may be returned to the target workspace and the target sub-workspace may be stopped. If the target workspace does not exist, the second resource occupied by the target sub-workspace may be directly release, and the target sub-workspace may be stopped, thereby achieving the purpose of stopping the target sub-workspace.

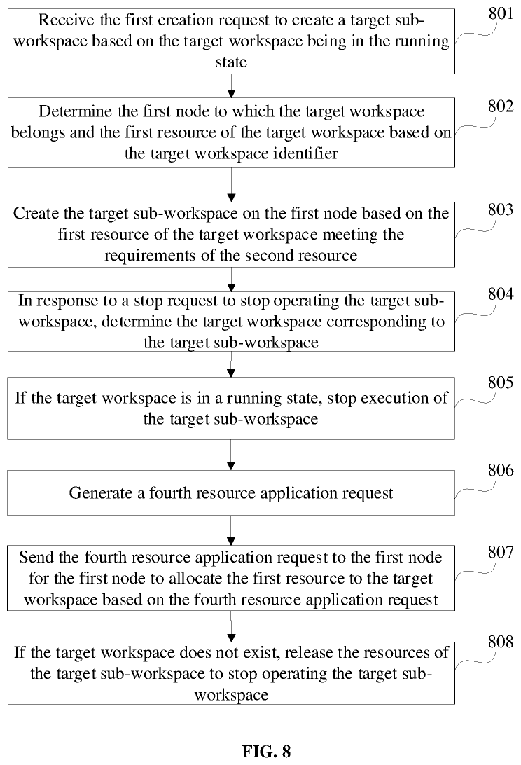

FIG. 8 is a flowchart of the workspace processing method according to an embodiment of the present disclosure. The method will be described in detail below.

801, receiving the first creation request to create a target sub-workspace based on the target workspace being in the operating state.

802, determining the first node to which the target workspace belongs and the first resource of the target workspace based on the target workspace identifier.

803, creating the target sub-workspace on the first node based on the first resource of the target workspace meeting the requirements of the second resource.

804, in response to a stop request to stop operating the target sub-workspace, determining the target workspace corresponding to the target sub-workspace.

The processes at 801 to 804 are consistent with the processes at 701 to 704, and will not be described in detail again.

805, if the target workspace is in an operating state, stopping execution of the target sub-workspace.

806, generating a fourth resource application request.

In some embodiments, the fourth resource application request may include the first resource required by the target workspace.

In some embodiments, if the target workspace is in the operating state, the second resource may be returned to the target workspace.

In some embodiments, the first resource required by the target workspace may be determined, and the first resource may be the sum of the second resource and the third resource.

In some embodiments, the first resource required by the target workspace may be determined based on the sorted first resource originally occupied by the target workspace, or may be determined based on the second resource occupied by the target sub-workspace and the third resource occupied by the target workspace.

In some embodiments, the fourth resource application request may be generated, and the fourth resource application request may include the first resource.

It should be noted that the order of stopping the target sub-workspace and generating the fourth resource application request is not limited to the order described above, and these processes can be executed at the same time or in any order.

807, sending the fourth resource application request to the first node such that the first node can allocate the first resource to the target workspace based on the fourth resource application request.

In some embodiments, the fourth resource application request may be sent to the/first node. After receiving the fourth resource application request, the first node may allocate the first resource to the target workspace based on the first resource therein.

In some embodiments, the fourth resource application request may also include the target workspace identifier such that the first node can determine the first resource allocate to it based on the target workspace identifier.

In some embodiments, after the target workspace is restarted based on the allocated first resource, the target workspace may run based on the first resource.

It should be noted that in a certain workspace, a plurality of sub-workspaces may be created, and each sub-workspace may share the resources of the workspace. If a sub-workspace stops, the resources occupied by the sub-workspace may be can be returned to the workspace.

808, if the target workspace does not exist, releasing the resources of the target sub-workspace to stop operating the target sub-workspace.

The process at 808 is consistent with the process at 706, and will not be described in detail again.

Consistent with the present disclosure, the workspace processing method may include generating a fourth resource application request, the fourth resource application request including the first resource required by the target workspace; and sending the fourth resource application request to the first node such that the first node can allocate the first resource to the target workspace based on the fourth resource application request. In this embodiment, the first resource required by the target workspace may be determined, and the fourth resource application request may be sent to the first node such that the first node can allocate the first resource to the target workspace based on the fourth resource application request, thereby achieving the purpose of returning the second resource occupied by the target sub-workspace to the target workspace.

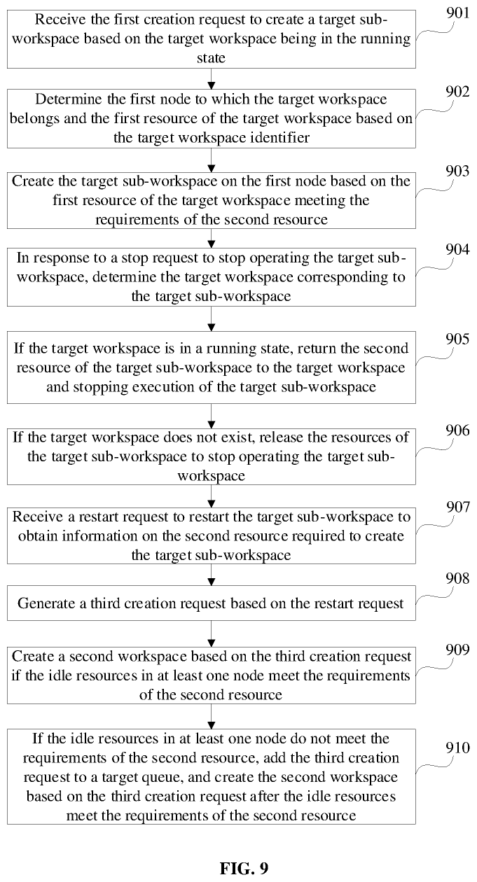

FIG. 9 is a flowchart of the workspace processing method according to an embodiment of the present disclosure. The method will be described in detail below.

901, receiving the first creation request to create a target sub-workspace based on the target workspace being in the operating state.

902, determining the first node to which the target workspace belongs and the first resource of the target workspace based on the target workspace identifier.

903, creating the target sub-workspace on the first node based on the first resource of the target workspace meeting the requirements of the second resource.

904, in response to a stop request to stop operating the target sub-workspace, determining the target workspace corresponding to the target sub-workspace.

905, if the target workspace is in an operating state, returning the second resource of the target sub-workspace to the target workspace and stopping execution of the target sub-workspace.

906, if the target workspace does not exist, releasing the resources of the target sub-workspace to stop operating the target sub-workspace.

The processes at 901 to 906 are consistent with the processes at 701 to 706, and will not be described in detail again.

907, receiving a restart request to restart the target sub-workspace to obtain information on the second resource required to create the target sub-workspace.

In some embodiments, after stopping the target sub-workspace, the operator may trigger the preset restart button and generate a restart request. After receiving the restart request to restart the target sub-workspace, information of the second resource required to create the target sub-workspace may be obtained. The information may include stored information of each workspace, such as information about the sub-workspaces that have been created (incubated) in the workspace, their nodes, occupied resources, etc.

In some embodiments, based on the stored information of each workspace, the information of the target sub-workspace may be determined. The information of the target sub-workspace may include the information of the second resource required to crate the target sub-workspace.

908, generating a third creation request based on the restart request.

In some embodiments, third creation request may carry information about the second resource required to create the target sub-workspace.

In some embodiments, if the target sub-workspace corresponding to the to-be-restarted target sub-workspace has stopped, the target sub-workspace may not be re-created using the resources of the target workspace. If the target workspace is in the operating state, the resources on the target workspace may no longer be able to meet the creation requirements of the target sub-workspace. Therefore, in order to ensure that the operation of each workspace on the platform is not affected, the target sub-workspace cannot be restarted after it is stopped.

In some embodiments, the third creation request may be generated based on the restart request, and the third creation request may carry information about the second resource required to create the target sub-workspace.

In some embodiments, the information on the second resource required to create the target sub-workspace may include the processor model, the number of processor resources, the number of storage space resources, etc.

909, creating a second workspace based on the third creation request if the idle resources in at least one node meet the requirements of the second resource.

In some embodiments, the at least one node may include the first node.

In some embodiments, whether the idle resources in the plurality of computing nodes meet the requirements of the second resource may be determined. If one or more computing nodes meet the requirement of the second workspace, one of the computing nodes may be selected to create the second workspace.

It should be noted that if the idle resources of the first node meet the requirements of the second resources, the second workspace may also be created on the first node.

910, if the idle resources in at least one node do not meet the requirements of the second resource, adding the third creation request to a target queue, and creating the second workspace based on the third creation request after the idle resources meet the requirements of the second resource.

In some embodiments, if the idle resources in the plurality of nodes do not meet the requirements of the second resource, the third creation request may be added to a target queue. The target queue may include a plurality of pending creation requests. When the idle resources in the resource pool meet the resource requirements of the creation request, a node can be allocated to the creation request to create the workspace, and placing the workspace in the operating state.

In some embodiments, the creation requests in the target queue may be executed in a first-in, first-out order.

Consistent with the present disclosure, the workspace processing method may also include receiving a restart request to restart the target sub-workspace to obtain information on the second resource required to create the target sub-workspace; generating a third creation request based on the restart request, the third creation request carrying information about the second resource required to create the target sub-workspace; creating a second workspace based on the third creation request if the idle resources in at least one node meet the requirements of the second resource, the at least one node including the first node; and if the idle resources in at least one node do not meet the requirements of the second resource, adding the third creation request to a target queue, and creating the second workspace based on the third creation request after the idle resources meet the requirements of the second resource. In this embodiment, after stopping the target sub-workspace, if a restart request is received to restart the target sub-workspace, based on the information of the second resource required by the target sub-workspace, a third creation request to create a new workspace can be generated, and a second workspace can be created on a node when the idle resources in the node meet the information requirements of the second resource. If no idle resources of the nodes meet the information requirements of the second resource, the third creation request can be added to a target queue and wait until the idle resources meet the requirement of the second resource, then the second workspace can be created.

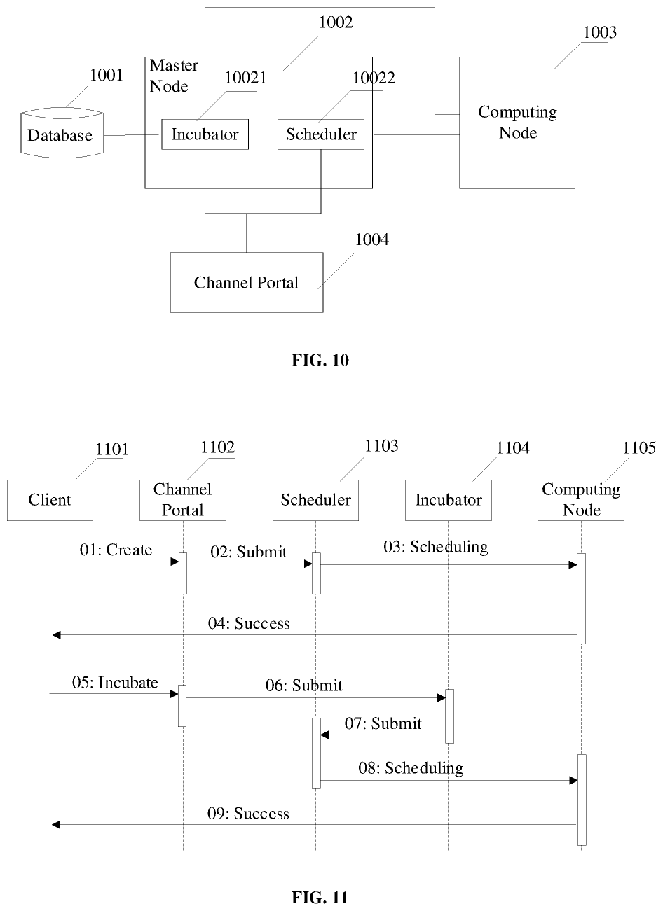

FIG. 10 is a schematic diagram of an application scenario of the workspace processing method according to an embodiment of the present disclosure. This scenario includes a database 1001, a master node 1002, a computing node 1003, and a platform portal 1004. The database 1001 may use the redis database to store various numerical controls on the platform, such as information on each computing node, workspace, sub-workspace, etc. The platform portal 1004 may be used to receive the creation request input by the operator to create a workspace, create a sub-workspace creation request, call various interfaces, etc. The computing node 1003 may be used to run each workspace (including the sub-workspaces). The master node 1002 may be used to determine which computing node can be used to create the workspace based on the creation parameters uploaded by the operator through the platform portal 1004, and which workspace can be used to create the target sub-workspace based on the uploaded creation parameters, etc.

In some embodiments, the master node 1002 may include an incubator 10021 and a scheduler 10022. The scheduler may be used to create a workspace based on the creation request, determine the computing node that meets the requirements, and control the computing node to allocate the corresponding resources to create the workspace. After the incubator receives the creation request to create a sub-workspace (which can also become an incubation request), the incubator may analyze the workspace and the required resources corresponding to the incubation request, generate a resource application request, and send the resource application request to the scheduler. In this way, the scheduler can control the creation of a sub-workspace based on the resources of the corresponding workspace on the corresponding computing node based on the resource application request, thereby realizing resource sharing for the workspace.

In a platform, the number of master nodes may be limited, which is generally an odd number, such as 1, 3, etc. There may be a plurality of computing nodes, and the workspaces on the computing nodes are generally allocated by the master nodes.

In some embodiments, the computing node may allocate resources based on the scheduler's scheduling. The scheduler may determine to share some resources in the workspace with the sub-workspaces incubated therein, and the computing node may determine which part of the resources can be shared with the sub-workspaces.

FIG. 11 is a sequence diagram for creating workspaces and sub-workspaces in an application scenario. In this sequence diagram, “create” is used to create a workspace, and “incubate” is used to create a sub-workspace in the workspace. The sequence diagram includes a client 1101, a platform portal 1102, a scheduler 1103, an incubator 1104, and a computing node 1105. The sequence diagram will be described in detail below.

01, the client 1101 generates a create request to the platform portal 1102

02, the platform portal 1102 submits the creation request to the scheduler 1103.

03, the scheduler 1103 schedules the computing node 1105 to create a workspace.

04, the computing node 1105 feeds back the success information to the client

1101.

05, the client 1101 generates an incubation request to the platform portal 1102.

06, the platform portal 1102 submits the incubation request to the incubator 1104.

07, the incubator 1104 generates a resource application request and submits it to the scheduler 1103.

08, the scheduler 1103 schedules the computing node 1105 to implement the incubation sub-workspace.

09, the computing node 1105 feeds back the success information to the client 1101.

Corresponding to the workspace processing method of the foregoing embodiments, the present disclosure also provides an embodiment of a device for applying the workspace processing method.

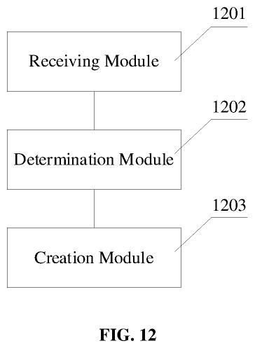

FIG. 12 is a schematic structural diagram of a workspace processing device according to an embodiment of the present disclosure. The workspace processing device includes a receiving module 1201, a determination module 1202, and a creation module 1203.

The receiving module 1201 may be configured to receive a first creation request to create a target sub-workspace based on the target workspace in an operating state, the first creation request including a target workspace identifier and a second resource required by the target sub-workspace.

The determination module 1202 may be configured to determine the first node to which the target workspace belongs and the first resource of the target workspace based on the target workspace identifier, the first resource being an available resource of the target workspace.

The creation module 1203 may be configured to create a target sub-workspace on the first node based on the first resource of the target workspace meeting the requirements of the second resource.

In some embodiments, the creation module may include a first creation unit and/or a second creation unit. The first creation unit may be configured to determine a second resource in the first resource of the target workspace in response to the second resource being less than the first resource, and create a target sub-workspace based on the second resource such that the target sub-workspace can run based on the second resource. The target workspace may run based on a third resource, and the third resource may be the remaining resource in the first resource other than the second resource. The second creation unit may be configured to determine the first resource of the target workspace as the second resource in response to the second resource not being less than the first resource, and crate a target sub-workspace based on the second resource such that the target sub-workspace can run based on the second resource, and the target workspace can stop operating.

In some embodiments, the first creation may be configured to generate a first resource application request. The first resource application request may include the target workspace location identifier and the second resource required by the target sub-workspace. The first creation may be further configured to generate a second resource application request. The second resource application request may include the target workspace location identifier and the third resource required by the target workspace. The first creation may be further configured to send the first resource application request and the second resource application request to the first node. In this way, the first node can allocate the second resource in the first resource to the target sub-workspace and allocate the third resource in the first resource to the target workspace based on the target workspace location identifier.

In some embodiments, the second creation may be configured to generate a third resource application request. The third resource application request may include the target workspace location identifier and the second resource required by the target sub-workspace. The second creation may be further configured to send the third resource application request to the first node. In this way, the first node can allocate the second resource to the target sub-workspace based on the target workspace location identifier and the third resource application request. The second creation may be further configured to execute a stop command to stop the execution of the target workspace.

In some embodiments, the workspace processing device may further include an addition module and a deletion module. The addition module may be configured to add an occupancy mark to the first node after determining the first node to which the target workspace belongs based on the target workspace identifier. The deletion module may be configured to delete the occupancy mark after the first node creates the target sub-workspace.

In some embodiments, the receiving module may be further configured to receive the second creation request to crate the first workspace, the determination module may be further configured to determine a second node in at least two nodes, the second node being a node with no added occupancy mark, and the creation module may be further configured to create the first workspace on the second node.

In some embodiments, the workspace processing device may further include a response module, a return module, and a release module. The response module may be configured to determine the target workspace corresponding to the target sub-workspace in response to a stop request to stop operating the target sub-workspace. The return module may be configured to return the second resource of the target sub-workspace to the target workspace and stop operating the target sub-workspace if the target workspace is in an operating state. The release module may be configured to release the resources of the target sub-workspace if the target workspace does not exist, thereby stopping the execution of the target sub-workspace.

In some embodiments, the return module may be configured to generate a fourth resource application request, the fourth resource application request including the first resource required by the target workspace; and send the fourth resource application request to the first node such that the first node can allocate the first resource to the target workspace based on the fourth resource application request.

In some embodiments, the workspace processing device may further include a restart module and a generation module. The restart module may be configured to receive a restart request to restart the target sub-space to obtain information on the second resource required to create the target sub-workspace. The generation module may be configured to generate a third creation request based on the restart request, the third creation request carrying information about the second resource required to crate the target sub-workspace.

Correspondingly, the creation module may be further configured to create a second workspace based on the third creation request if the idle resources in at least one node meet the requirements of the second resource, the at least one node including the first node. The creation module may be further configured to add the third creation request to the target queue if the idle resources in at least one node do not meet the requirements of the second resource, and create the second workspace based on the third creation request after the idle resources meet the requirements of the second resource.

The functional modules or units described in the present disclosure may be implemented by software components, hardware components, or a combination of software and hardware components. For example, a module or a unit may be implemented as one or more computer programs, when executed by one ore more processors, performs the desired function.

It should be noted that for the functional explanation of each part in the workspace processing device provided in this embodiment, reference can be made to the explanation in the foregoing embodiments, which will not be repeated here.

Consistent with the present disclosure, in the workspace processing device provided by the embodiments of the present disclosure, after the target workspace has been created, if another workspace is created a target sub-workspace can be crated in the target workspace that has been created and is operating, without waiting for resource allocation in the platform. The available resources in the target workspace can be used to create the target sub-workspace at the first node of the target workspace, thereby reducing the waiting time for creating a workspace required by the user.

Corresponding to the workspace processing method provided in the foregoing embodiments, embodiments of the present disclosure also provide an electronic device and a computer-readable storage medium corresponding to the workspace processing method.

The electronic device may include a memory and a processor. The memory stores a processing program that, when being executed by the processor, causes the processor to implement each step of the workspace processing method as described in the foregoing embodiments.

For specific implementation of the workspace processing method of the electronic device, reference can be made to the foregoing workspace processing method embodiments.

More specifically, a computer program stored in the readable storage medium can be executed to implement the workspace processing method. For detail, reference can be made to the foregoing workspace processing method embodiments.

The various embodiments in this specification are described in a progressive manner, and each embodiment focuses on the differences from other embodiments, and the same and similar parts between the various embodiments can be referred to each other. The devices provided in the present disclosure correspond to the methods provided by the present disclosure, the description of the devices is relatively simple, and the related part can be referred to the description of the methods.

The above description of the embodiments is provided to enable those skilled in the art to make or use the present disclosure. Various modifications to these embodiments can be readily apparent to those skilled in the art, and the generic principles defined herein may be implemented in other embodiments without departing from the spirit or scope of the present disclosure. Therefore, the present disclosure is not intended to be limited to the embodiments shown herein, but is to be accorded the widest scope consistent with the principles and novel features provided herein.

What is claimed is:

1. A workspace processing method comprising:
receiving a first creation request to create a target sub-workspace based on a target workspace being in an operating state, the first creation request including a target workspace identifier and a second resource required by the target sub-workspace;
determining a first node to which the target workspace belongs and a first resource of the target workspace based on the target workspace identifier, the first resource being an available resource of the target workspace; and
creating the target sub-workspace on the first node based on the first resource of the target workspace meeting requirements of the second resource.

2. The workspace processing method of claim 1, wherein creating the target sub-workspace on the first node based on the first resource of the target workspace meeting the requirements of the second resource includes any one of:
in response to the second resource being less than the first resource, determining the second resource in the first resource and creating the target sub-workspace based on the second resource for the target sub-workspace to run based on the second resource and the target workspace to run based on a third resource, the third resource being remaining resources in the first resource other than the second resource; and
in response to the second resource not being less than the first resource, determining the first resource of the target workspace as the second resource and creating the target sub-workspace based on the second resource for the target sub-workspace to run based on the second resource and the target workspace to stop operating.

3. The workspace processing method of claim 2, wherein determining the second resource in the first resource of the target workspace and creating the target sub-workspace based on the second resource includes:
generating a first resource application request, the first resource application request including a target workspace location identifier and the second resource required by the target sub-workspace;
generating a second resource application request, the second resource application request including the target workspace location identifier and the third resource required by the target workspace; and
sending the first resource application request and the second resource application request to the first node for the first node to allocate the second resource in the first resource to the target sub-workspace, and allocate the third resource in the first resource to the target workspace based on the target workspace location identifier.

4. The workspace processing method of claim 2, wherein determining the first resource of the target workspace as the second resource and creating the target sub-workspace based on the second resource includes:
generating a third resource application request, the third resource application request including the target workspace location identifier and the second resource required by the target sub-workspace;
sending the third resource application request to the first node for the first node to allocate the second resource to the target sub-workspace based on the target workspace location identifier and the third resource application request; and
executing a stop command to stop operating of the target workspace.

5. The workspace processing method of claim 1, after determining the first node to which the target workspace belongs based on the target workspace identifier further comprising:
adding an occupancy mark to the first node;
correspondingly, after the first node creates the target sub-workspace further comprising:
deleting the occupancy mark.

6. The workspace processing method of claim 5 further comprising:
receiving a second creation request to create a first workspace;
determining a second node in at least two nodes, the second node being a node with no occupancy mark added; and
creating the first workspace on the second node.

7. The workspace processing method of claim 1, after the first node creates the target sub-workspace further comprising:
in response to a stop request to stop operating the target sub-workspace, determining the target workspace corresponding to the target sub-workspace;
if the target workspace is in the operating state, returning the second resource of the target sub-workspace to the target workspace and stopping operating the target sub-workspace; and
if the target workspace does not exist, releasing the resource of the target sub-workspace to stop operating the target sub-workspace.

8. The workspace processing method of claim 7, wherein returning the second resource of the target sub-workspace to the target workspace includes:
generating a fourth resource application request, the fourth resource application request including the first resource required by the target workspace; and
sending the fourth resource application request to the first node for the first node to allocate the first resource to the target workspace based on the fourth resource application request.

9. The workspace processing method of claim 7, after stopping operating the target sub-workspace further comprising:
receiving a restart request to restart the target sub-workspace to obtain information about the second resource required to create the target sub-workspace;
generating a third creation request based on the restart request, the third creation request carrying information about the second resource required to create the target sub-workspace;
if idle resources in at least one node meet the requirements of the second resource, creating a second workspace based on the third creation request, the at least one node including the first node; and
if the idle resources in the at least one node do not meet the requirements of the second resource, adding the third creation request to a target queue, and creating the second workspace based on the third creation request after the idle resources meet the requirements of the second resource.

10. A workspace processing device comprising:
a receiving module, the receiving module being configured to receive a first creation request to create a target sub-workspace based on a target workspace being in an operating state, the first creation request including a target workspace identifier and a second resource required by the target sub-workspace;
a determination module, the determination module being configured to determine a first node to which the target workspace belongs and a first resource of the target workspace based on the target workspace identifier, the first resource being an available resource of the target workspace; and
a creation module, the creation module being configured to create the target sub-workspace on the first node based on the first resource of the target workspace meeting requirements of the second resource.

11. The data processing device of claim 10, wherein:
the creation module includes a first creation unit and a second creation unit,
the first creation unit being configured to:
in response to the second resource being less than the first resource, determine the second resource in the first resource and create the target sub-workspace based on the second resource for the target sub-workspace to run based on the second resource and the target workspace to run based on a third resource, the third resource being remaining resources in the first resource other than the second resource; and
the second creation unit being configured to:
in response to the second resource not being less than the first resource, determine the first resource of the target workspace as the second resource and create the target sub-workspace based on the second resource for the target sub-workspace to run based on the second resource and the target workspace to stop operating.

12. The workspace processing device of claim 11, wherein the first creation unit is further configured to:
generate a first resource application request, the first resource application request including a target workspace location identifier and the second resource required by the target sub-workspace;
generate a second resource application request, the second resource application request including the target workspace location identifier and the third resource required by the target workspace; and
send the first resource application request and the second resource application request to the first node for the first node to allocate the second resource in the first resource to the target sub-workspace, and allocate the third resource in the first resource to the target workspace based on the target workspace location identifier.

13. The workspace processing device of claim 11, wherein the second creation unit is further configured to:
generate a third resource application request, the third resource application request including the target workspace location identifier and the second resource required by the target sub-workspace;
send the third resource application request to the first node for the first node to allocate the second resource to the target sub-workspace based on the target workspace location identifier and the third resource application request; and
execute a stop command to stop operating of the target workspace.

14. The workspace processing device of claim 10 further comprising:
an addition module and a deletion module,
the addition module being configured to:
add an occupancy mark to the first node; and
the deletion module being configured to:
delete the occupancy mark after the first node creates the target sub-workspace.

15. The workspace processing device of claim 14, wherein:
the receiving module is further configured to receive a second creation request to create a first workspace;
the determination module is further configured to determine a second node in at least two nodes, the second node being a node with no occupancy mark added; and
the creation module is further configured to create the first workspace on the second node.

16. The workspace processing device of claim 10 further comprising:
a response module, a return module, and a release module,
the response module being configured to:
in response to a stop request to stop operating the target sub-workspace, determine the target workspace corresponding to the target sub-workspace;
the return module being configured to:
if the target workspace is in the operating state, return the second resource of the target sub-workspace to the target workspace and stop operating of the target sub-workspace; and
the release module being configured to:
if the target workspace does not exist, release the resource of the target sub-workspace to stop operating the target sub-workspace.

17. The workspace processing device of claim 16, wherein the return module is further configured to:
generate a fourth resource application request, the fourth resource application request including the first resource required by the target workspace; and
send the fourth resource application request to the first node for the first node to allocate the first resource to the target workspace based on the fourth resource application request.

18. The workspace processing device of claim 16 further comprising:
a restart module and a generation module,
the restart module being configured to:
receive a restart request to restart the target sub-workspace to obtain information about the second resource required to create the target sub-workspace;
the generation module being configured to:
generate a third creation request based on the restart request, the third creation request carrying information about the second resource required to create the target sub-workspace, wherein:
the creation module is further configured to:
if idle resources in at least one node meet the requirements of the second resource, create a second workspace based on the third creation request, the at least one node including the first node, and
if the idle resources in the at least one node do not meet the requirements of the second resource, add the third creation request to a target queue, and create the second workspace based on the third creation request after the idle resources meet the requirements of the second resource.

19. An electronic device comprising:
a processor; and
a memory storing a computer program that, when executed, causes the processor to:
receive a first creation request to create a target sub-workspace based on a target workspace being in an operating state, the first creation request including a target workspace identifier and a second resource required by the target sub-workspace;
determine a first node to which the target workspace belongs and a first resource of the target workspace based on the target workspace identifier, the first resource being an available resource of the target workspace; and
create the target sub-workspace on the first node based on the first resource of the target workspace meeting requirements of the second resource.

20. The electronic device of claim 19, wherein the computer program further causes the processor to:
in response to the second resource being less than the first resource, determine the second resource in the first resource and create the target sub-workspace based on the second resource for the target sub-workspace to run based on the second resource and the target workspace to run based on a third resource, the third resource being remaining resources in the first resource other than the second resource; and
in response to the second resource not being less than the first resource, determine the first resource of the target workspace as the second resource and create the target sub-workspace based on the second resource for the target sub-workspace to run based on the second resource and the target workspace to stop operating.
